(19) United States
(12) Patent Application Publication
(10) Pub. No.: US 2026/0009692 A1
(43) Pub. Date: Jan. 8, 2026

(54) METHOD AND SYSTEM FOR DETECTING LIQUID LEAKAGE DETECTION LINE, AND COOLING DEVICE

(71) Applicant: SUZHOU METABRAIN INTELLIGENT TECHNOLOGY CO.,LTD., Jiangsu (CN)

(72) Inventor: Qi GONG, Jiangsu (CN)

(73) Assignee: SUZHOU METABRAIN INTELLIGENT TECHNOLOGY CO.,LTD., Jiangsu (CN)

(21) Appl. No.: 18/993,069

(22) PCT Filed: Aug. 15, 2023
(86) PCT No.: PCT/CN2023/113169

§ 371 Date: Jan. 10, 2025

(30) Foreign Application Priority Data
Nov. 30, 2022 (CN) 202211520790.7

(51) Int. Cl. G01M 3/18

(52) U.S. Cl. CPC G01M 3/18

(57) ABSTRACT

Disclosed are a method, system, and device for detecting a liquid leakage detection line, a server, and an electronic apparatus. The method includes setting a voltage value output by a first target port to a preset voltage value according to a first preset frequency, and assigning a first flag to a target flag bit; measuring a voltage value output by a second target port according to a second preset frequency, so as to obtain a first measurement result, and measuring the target flag bit according to the second preset frequency, so as to obtain a second measurement result; and determining a working state of the liquid leakage detection line according to the first measurement result and the second measurement result. The problem that the working state of the liquid leakage detection line fails to be determined in time and tends to be determined mistakenly because failure diagnosis of the liquid leakage detection line is performed with manual routine inspection in the related art is solved.

### CROSS-REFERENCE TO RELATED APPLICATION

This application is a National Stage Application of International Application No. PCT/CN2023/113169 filed on Aug. 15, 2023, which claims the benefit of Ser. No. 202211520790.7 filed on Nov. 30, 2022, in China, and which applications are incorporated herein by reference. To the extent appropriate, a claim of priority is made to each of the above disclosed applications.

### TECHNICAL FIELD

Examples of the disclosure relate to the field of computers, and in particular to a method and system for detecting a liquid leakage detection line, and a cooling device.

### BACKGROUND

In the related art, to avoid a failure of a server in a case that a liquid cooling plate has a leakage failure in a working process, a liquid leakage detection line is generally arranged in the liquid cooling plate, so as to detect whether the liquid cooling plate has the leakage failure. However, failure diagnosis of the liquid leakage detection line can only be manually determined by operation and maintenance personnel in the related art. In consequence, it is impossible to determine whether the liquid leakage detection line has the failure in time, affecting smooth operation of the server.

### SUMMARY

A method and system for detecting a liquid leakage detection line, and a cooling device are provided in examples of the disclosure.

A method for detecting a liquid leakage detection line is provided according to an example of the disclosure. The method includes a voltage value output by a first target port is set to a preset voltage value according to a first preset frequency, and a first flag is assigned to a target flag bit, and the first flag is configured to indicate that the voltage value output by the first target port is set to the preset voltage value, the voltage value output by the first target port is configured to adjust a resistance value of the liquid leakage detection line, the first preset frequency is a frequency used when the voltage value output by the first target port is set to the preset voltage value, the liquid leakage detection line is arranged on a cooling device of a target motherboard, and the first target port is arranged on the target motherboard; a voltage value output by a second target port is measured according to a second preset frequency, so as to obtain a first measurement result, and measuring the target flag bit according to the second preset frequency, so as to obtain a second measurement result, where the voltage value output by the second target port is determined by the resistance value of the liquid leakage detection line, and the second target port is arranged on the target motherboard; and a working state of the liquid leakage detection line is determined according to the first measurement result and the second measurement result.

In some embodiments, the working state of the liquid leakage detection line is determined according to the first measurement result and the second measurement result includes that the working state is a normal working state is determined in a case that the first measurement result indicates that the voltage value output by the second target port is not greater than a first preset voltage threshold and the second measurement result indicates that the target flag bit is the first flag; and that the working state is an abnormal working state is determined in a case that the first measurement result indicates that the voltage value output by the second target port is not less than a second preset voltage threshold and the second measurement result indicates that the target flag bit is the first flag; where the second preset voltage threshold is greater than the first preset voltage threshold.

In some embodiments, the abnormal working state includes at least one of aging of the liquid leakage detection line and breakage of the liquid leakage detection line.

In some embodiments, the resistance value of the liquid leakage detection line is configured to indicate whether the liquid leakage detection line detects a leakage failure; the resistance value of the liquid leakage detection line is a first-type resistance value in a case that the voltage value output by the second target port is not greater than the first preset voltage threshold, and the first-type resistance value is configured to indicate that the liquid leakage detection line detects the leakage failure; and the resistance value of the liquid leakage detection line is a second-type resistance value in a case that the voltage value output by the second target port is not less than the second preset voltage threshold, and the second-type resistance value is configured to indicate that the liquid leakage detection line detects no leakage failure.

In some embodiments, after that the working state is an abnormal working state is determined, the method for detecting a liquid leakage detection line further includes position information is determined of the liquid leakage detection line in a server; first failure reminding information is generated according to the position information, and the first failure reminding information is transmitted to a target object, where the first failure reminding information is configured to remind the target object of a failure of the liquid leakage detection line, and the position information of the liquid leakage detection line.

In some embodiments, position information of the liquid leakage detection line is determined in a server includes liquid leakage detection line identification information of the liquid leakage detection line is acquired, where the liquid leakage detection line identification information includes server identification information of the server where the liquid leakage detection line is located, and a serial number of the liquid leakage detection line; and the position information of the liquid leakage detection line is determined in the server according to the liquid leakage detection line identification information.

In some embodiments, the position information of the liquid leakage detection line is determined in the server according to the liquid leakage detection line identification information includes a ranking mode of the liquid leakage detection line is determined in the server according to the server identification information; and the position information of the liquid leakage detection line in the server is determined according to the ranking mode and the serial number.

In some embodiments, the method for detecting a liquid leakage detection line further includes that the server where the liquid leakage detection line is located has a leakage failure is determined in a case that the first measurement result indicates that the voltage value output by the second target port is not less than a second preset voltage threshold and the second measurement result indicates that the target flag bit is a second flag, where the second flag is configured to indicate that the voltage value output by the first target port is not set to the preset voltage value.

In some embodiments, after that the server where the liquid leakage detection line is located has a leakage failure is determined, the method for detecting a liquid leakage detection line further includes failure position information of the leakage failure in the server is determined; and second failure reminding information is generated according to the position information, and the second failure reminding information is transmitted to a target object, where the failure reminding information is configured to remind the target object of the leakage failure of the server, and the failure position information of the leakage failure.

In some embodiments, the failure position information of the leakage failure in the server is determined includes liquid leakage detection line identification information of the liquid leakage detection line is acquired, where the liquid leakage detection line identification information includes server identification information of the server where the liquid leakage detection line is located, and a serial number of the liquid leakage detection line; and a detection region is determined corresponding to the liquid leakage detection line in the server according to the liquid leakage detection line identification information; and the failure position information is determined according to the detection region, where the failure position information includes information of the detection region.

In some embodiments, before the voltage value output by a first target port is set to a preset voltage value according to a first preset frequency, the method for detecting a liquid leakage detection line further includes a first thread and a second thread are created, where the first thread is configured to set the voltage value output by the first target port to the preset voltage value according to the first preset frequency, and assign the first flag to the target flag bit; the second thread is configured to obtain the first measurement result and the second measurement result according to the second preset frequency; and the second preset frequency is greater than the first preset frequency.

In some embodiments, the first thread is further configured to cancel setting of the voltage value output by the first target port to the preset voltage value, and assign a second flag to the target flag bit, with an interval of a preset time period after the voltage value output by the first target port is set to the preset voltage value, and the first flag is assigned to the target flag bit.

In some embodiments, duration of the preset time period is longer than that of a time cycle corresponding to the second preset frequency.

A cooling device is provided according to another example of the disclosure. The cooling device includes a liquid cooling plate, a liquid leakage detection line, a first target port, and a second target port; where the liquid leakage detection line is arranged in the liquid cooling plate, and configured to detect whether the liquid cooling plate has a leakage failure; the first target port is configured to adjust a resistance value of the liquid leakage detection line; and the second target port is configured to output a voltage value determined by the resistance value of the liquid leakage detection line.

A system for detecting a liquid leakage detection line is provided according to yet another example of the disclosure. The system includes a baseboard management controller, a liquid leakage detection line, a first target port, and a second target port; where the first target port is configured to adjust a resistance value of the liquid leakage detection line; the second target port is configured to output a voltage value determined by the resistance value of the liquid leakage detection line; and the baseboard management controller is configured to set a voltage value output by the first target port to a preset voltage value according to a first preset frequency, and assign a first flag to a target flag bit, where the first flag is configured to indicate that the voltage value output by the first target port is set to the preset voltage value, the voltage value output by the first target port is configured to adjust the resistance value of the liquid leakage detection line, the first preset frequency is a frequency used when the voltage value output by the first target port is set to the preset voltage value, the liquid leakage detection line is arranged on a cooling device of a target motherboard, and the first target port is arranged on the target motherboard; measure a voltage value output by the second target port according to a second preset frequency, so as to obtain a first measurement result, and measure the target flag bit according to the second preset frequency, so as to obtain a second measurement result, where the voltage value output by the second target port is determined by the resistance value of the liquid leakage detection line, and the second target port is arranged on the target motherboard; and determine a working state of the liquid leakage detection line according to the first measurement result and the second measurement result.

In some embodiments, the system for detecting a liquid leakage detection line further includes an alarm device, where the alarm device is connected to the baseboard management controller, and configured to transmit alarm information to a target object in a case that the baseboard management controller determines that the working state of the liquid leakage detection line is an abnormal state according to the first measurement result and the second measurement result, and the alarm information includes position information of the liquid leakage detection line.

### BRIEF DESCRIPTION OF THE DRAWINGS

FIG. 1 is a structural block diagram of an electronic apparatus according to an example of the disclosure;

FIG. 2 is a flowchart of a method for detecting a liquid leakage detection line according to an example of the disclosure;

FIG. 3 is a structural block diagram of a system for detecting a liquid leakage detection line according to an example of the disclosure;

FIG. 4 is a structural block diagram of a server according to an example of the disclosure;

FIG. 5 is a structural block diagram of a device for detecting a liquid leakage detection line according to an example of the disclosure;

FIG. 6 is a structural block diagram of a cooling device according to an example of the disclosure;

FIG. 7 is a structural block diagram of a non-volatile readable storage medium according to an example of the disclosure; and

FIG. 8 is a structural block diagram of an electronic apparatus according to an example of the disclosure.

### DETAILED DESCRIPTION OF THE EMBODIMENTS

In order to enable those skilled in the art to better understand solutions of the disclosure, the technical solutions in examples of the disclosure will be clearly and comprehensively described below in conjunction with the accompanying drawings in the examples of the disclosure. Apparently, the examples described are merely some examples rather than all examples of the disclosure. Based on the examples of the disclosure, all other examples derived by those of ordinary skill in the art without creative efforts should fall within the scope of protection of the disclosure.

It should be noted that the terms “first”, “second”, etc. in the description, the claims, and the above accompanying drawings of the disclosure are used to distinguish between similar objects, instead of necessarily describing a particular sequence or a successive order. It should be understood that data used in this way can be interchanged where appropriate, so that the examples of the disclosure described herein can be implemented in other sequences than those illustrated or described herein. In addition, the terms “comprise”, “include”, “have”, and their any variations are intended to cover non-exclusive inclusions. For example, a process, a method, a system, a product, or an apparatus encompassing a series of steps or units can include other steps or units that are not explicitly listed or are inherent to the process, method, product, or apparatus, without being limited to those steps or units explicitly listed.

In order to better understand the examples of the disclosure, the technical terms involved in the examples of the disclosure are explained as follows:

The baseboard management controller (BMC) is a server-specific management controller. One of main functions of the BMC is to automatically monitor an operation state of a server, mainly including a health state of each kind of hardware. The BMC monitors the health state of each kind of hardware, and obtains information about each kind of hardware, so that operation and maintenance personnel can know the operation state of the server in time, and normal operation of the server can be ensured.

The cold plate type liquid cooling technology is to transfer heat from a high-temperature region to a remote position, and then perform cooling by means of a working fluid as an intermediate heat transfer medium. In the technology, the working liquid is separated from an object to be cooled, and transfers the heat of the object to be cooled to a refrigerant through an efficient heat conduction member such as a liquid cooling plate, without making direct contact with an electronic device. Thus, the cold plate type liquid cooling technology is also called an indirect liquid cooling technology.

The liquid leakage detection line is a type of cable having a resistance value changed when wetted with water. According to the characteristic of change in resistance value, the liquid leakage detection line is connected between a leakage detection general purpose input/output (GPIO) and an external resistor. When the server leaks, the resistance value of the cable is changed, a value of the leakage detection GPIO is pulled down, and thus it is detected that the server leaks.

The liquid leakage detection line in-place detection GPIO is another type of GPIO, used to simulate actual leakage. When a value of the GPIO is changed, resistance values at two ends of the liquid leakage detection line are also changed. Whether the liquid leakage detection line is in place and whether the function is normal are determined according to the change in value of the leakage detection GPIO.

The server will generate a large quantity of heat during normal working. These heat will cause a temperature of the server to be too high, thus affecting working performance of the server. In order to prevent the temperature of the server from being too high, it is common practice to cool the server through a liquid plate type liquid cooling technology at present. The liquid plate type liquid cooling technology is to transfer heat from a high-temperature region to a remote position, and then perform cooling by means of a working fluid as an intermediate heat transfer medium. In the technology, the working liquid is separated from an object to be cooled, and transfers the heat of the object to be cooled to a refrigerant through an efficient heat conduction member such as a liquid cooling plate, without making direct contact with an electronic device. Thus, the liquid plate type liquid cooling technology is also called an indirect liquid cooling technology.

In order to avoid a failure of the server in a case that the liquid cooling plate has a leakage failure in a working process, in an operation process of a cold plate type liquid cooling server, it is required to monitor whether the liquid cooling plate leaks all the time. Once leakage occurs, an alarm should be given in time, so that burnout of a motherboard or even large-scale electrical leakage and connection in a computer room after a large number of liquids leak can be avoided. In general, leakage detection is implemented based on the characteristic that the liquid leakage detection line has a change in resistance value after immersed in a liquid. Accordingly, in order to implement the normal leakage detection function without actual leakage in the operation process of the server, in a case that the BMC has not given an alarm correctly, at first, it should be ensured that in the operation process of the server, the characteristic that the liquid leakage detection line has a change in resistance value after immersed in a liquid is normal, and the liquid leakage detection line is not aged, damaged, etc. However, in the related art, since the failure diagnosis of the liquid leakage detection line is performed depending on manual routine inspection by operation and maintenance personnel, it is impossible to know whether the liquid leakage detection line has a failure in time, and the server may be impossible to work due to the failure of the liquid leakage detection line. In order to solve the problem, relevant solutions according to the examples of the disclosure are described in detail below.

A method example of a method for detecting a liquid leakage detection line is provided in the examples of the disclosure. It should be noted that steps shown in the flowcharts of the accompanying drawings can be executed in a computer system, such as a set of computer-executable instructions. Moreover, although logical orders are shown in the flowcharts, in some cases, the steps shown or described can be executed in an order different from those herein.

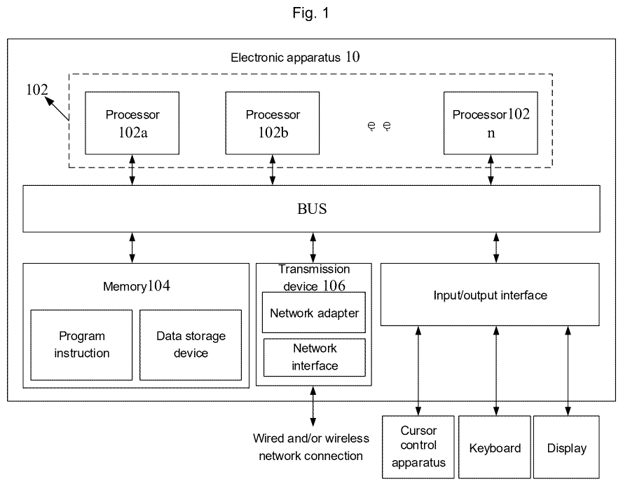

The method example according to the examples of the disclosure can be executed in a mobile terminal, a computer terminal, or a similar electronic apparatus. FIG. 1 is a structural block diagram of hardware of an electronic apparatus configured to implement the method for detecting a liquid leakage detection line. As shown in FIG. 1, the electronic apparatus 10 may include one or more processors 102 (shown as 102a, 102b, . . . , and 102n in the figure), a memory 104 configured to store data, and a transmission module 106 configured for a communication function, where the processor 102 may include, but is not limited to, a microcontroller unit (MCU), a field programmable gate array (FPGA), etc. In addition, the electronic apparatus may further include a display, an input/output interface (I/O interface), a universal serial bus (USB) port (which may be included as one of ports of a bus), a network interface, a power supply, and/or a camera. Those skilled in the art can understand that the structure shown in FIG. 1 is merely illustrative, and does not limit the structure of the above electronic apparatus. For example, the computer terminal 10 may further include more or fewer components than those shown in FIG. 1, or have a configuration different from that shown in FIG. 1.

It should be noted that the above one or more processors 102 and/or other data processing circuits may generally be referred to as “data processing circuits” herein. The data processing circuits may be embodied as software, hardware, firmware, or any other combinations in all or in part. In addition, the data processing circuits may be single stand-alone processing modules, or incorporated in all or in part into any one of other elements in the computer terminal 10 (or the mobile apparatus). As involved in the examples of the disclosure, the data processing circuits act as a type of processor control (for example, configured to select a variable resistance termination path connected to the interface).

It should be noted that in some examples, the above one or more processors 102 may be integrated in the baseboard management controller.

The memory 104 may be configured to store a software program and a module of application software, for example, a program instruction/data storage device corresponding to the method for detecting a liquid leakage detection line in the examples of the disclosure. The processor 102 runs the software program and module stored in the memory 104, so as to execute various function applications and data processing, i.e. to implement the method for leakage detection of the above application. The memory 104 may include a high-speed random access memory, and may further include a non-volatile memory, such as one or more magnetic storage devices, flash memories, and other non-volatile solid-state memories. In some instances, the memory 104 may further include memories remotely configured relative to the processor 102. These remote memories may be connected to the computer terminal 10 via a network. The instances of the above network include, but are not limited to, the Internet, an intranet, a local area network, a mobile communication network, and their combinations.

The transmission device 106 is configured to receive or transmit data via one network. The specific instances of the above network may include a wireless network provided by a communication provider of the computer terminal 10. In an instance, the transmission device 106 includes a network interface controller (NIC) that may be connected to other network apparatuses through a base station, so as to communicate with the Internet. In an instance, the transmission device 106 may be a radio frequency (RF) module that is configured to communicate with the Internet wirelessly.

The display may be, for example, a touch screen type liquid crystal display (LCD) that can enable a user to interact with a user interface of the computer terminal 10 (or the mobile apparatus).

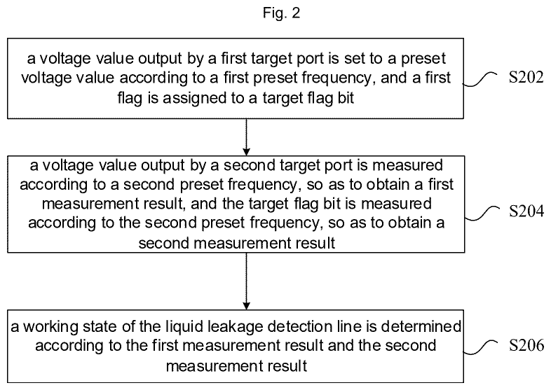

Under the above operation environment, a method for detecting a liquid leakage detection line is provided in the examples of the disclosure. As shown in FIG. 2, the method includes:

S202, a voltage value output by a first target port is set to a preset voltage value according to a first preset frequency, and a first flag is assigned to a target flag bit, where the first flag is configured to indicate that the voltage value output by the first target port is set to the preset voltage value, the voltage value output by the first target port is configured to adjust a resistance value of the liquid leakage detection line, the first preset frequency is a frequency used when the voltage value output by the first target port is set to the preset voltage value, the liquid leakage detection line is arranged on a cooling device of a target motherboard, and the first target port is arranged on the target motherboard.

In the technical solution according to S202, the resistance value of the liquid leakage detection line indicates output resistance between a first conductor and a second conductor of the liquid leakage detection line.

Optionally, the liquid leakage detection line includes the first conductor, the second conductor, and a filling medium, where the first conductor and the second conductor are each arranged at one side of the filling medium, and the filling medium has a change in resistance value after making contact with a medium in a liquid cooling plate, so that the output resistance between the first conductor and the second conductor, i.e. the resistance of the liquid leakage detection line in the disclosure is changed accordingly. Thus, after the resistance value of the filling medium is changed, a value of the output resistance between the first conductor and the second conductor is changed accordingly. The first conductor may also be connected to the second conductor through a controllable switch, and the controllable switch is connected to the first target port. When the first target port outputs the preset voltage value, the controllable switch is in a closed state, the first conductor and the second conductor are short-circuited, and the output resistance between the first conductor and the second conductor is located within a failure resistance value interval. The above failure resistance value interval indicates a value range of output resistance generated when the liquid leakage detection line detects a leakage failure.

S204, a voltage value output by a second target port is measured according to a second preset frequency, so as to obtain a first measurement result, and the target flag bit is measured according to the second preset frequency, so as to obtain a second measurement result, where the voltage value output by the second target port is determined by the resistance value of the liquid leakage detection line, and the second target port is arranged on the target motherboard.

It should be noted that in the technical solutions according to S202 and S204, since a leakage accident poses a great threat to the safe and stable operation of the server, it is required to closely monitor whether the cooling device leaks. Since the probability that the liquid leakage detection line has a failure is low, in some examples, the second preset frequency is greater than the first preset frequency. For example, the first preset frequency may be used when the voltage value output by the first target port is set to the preset voltage value every 24 hours or other time cycles set by the operation and maintenance personnel, and the second preset frequency may be used when the voltage value output by the second target port is measured once per second or other time cycles set by the operation and maintenance personnel.

In some examples of the disclosure, before the technical solution according to S202 is executed, a first thread and a second thread may also be set, where the first thread is configured to set the voltage value output by the first target port to the preset voltage value according to the first preset frequency, and assign the first flag to the target flag bit; and the second thread is configured to obtain the first measurement result and the second measurement result according to the second preset frequency.

As an optional embodiment, the first thread is further configured to cancel setting of the voltage value output by the first target port to the preset voltage value, and assign a second flag to the target flag bit, with an interval of a preset time period after the voltage value output by the first target port is set to the preset voltage value, and the first flag is assigned to the target flag bit.

It should be noted that duration of the above preset time period is longer than that of a time cycle corresponding to the second preset frequency.

Optionally, the first thread and the second thread may be created in the baseboard management controller. The first thread is configured to periodically pull down the liquid leakage detection line in-place detection GPIO, so as to simulate a leakage event. Thus, whether the liquid leakage detection line is in place and whether the leakage event can be correctly identified are periodically monitored. The second thread is configured to periodically detect the leakage detection GPIO. Thus, whether the leakage event occurs and whether an abnormal event of the liquid leakage detection line occurs are determined. In a case of the leakage event and the abnormal event of the liquid leakage detection line, an alarm is given in time.

S206, a working state of the liquid leakage detection line is determined according to the first measurement result and the second measurement result.

In the technical solution according to S206, the step that a working state of the liquid leakage detection line is determined according to the first measurement result and the second measurement result includes it is determined that the working state is a normal working state in a case that the first measurement result indicates that the voltage value output by the second target port is not greater than a first preset voltage threshold, and the second measurement result indicates that the target flag bit is a first flag; and it is determined that the working state is an abnormal working state in a case that the first measurement result indicates that the voltage value output by the second target port is not less than a second preset voltage threshold, and the second measurement result indicates that the target flag bit is the first flag; where the second preset voltage threshold is greater than the first preset voltage threshold. The abnormal working state includes aging of the liquid leakage detection line and breakage of the liquid leakage detection line.

It should be noted that the resistance value of the liquid leakage detection line is configured to indicate whether the liquid leakage detection line detects the leakage failure; where the resistance value of the liquid leakage detection line is a first-type resistance value in a case that the voltage value output by the second target port is not greater than the first preset voltage threshold, and the first-type resistance value is configured to indicate that the liquid leakage detection line detects the leakage failure or the liquid leakage detection line is configured to detect the leakage failure; and the resistance value of the liquid leakage detection line is a second-type resistance value in a case that the voltage value output by the second target port is not less than the second preset voltage threshold, and the second-type resistance value is configured to indicate that the liquid leakage detection line detects no leakage failure.

In order to ensure the normal operation of the cooling device and the stable operation of the server, after the step that it is determined that the working state is an abnormal working state, the method for detecting a liquid leakage detection line further includes position information of the liquid leakage detection line in the server is determined; and first failure reminding information is generated according to the position information, and transmitted to a target object, where the first failure reminding information is configured to remind the target object of a failure of the liquid leakage detection line, and the position information of the liquid leakage detection line.

Optionally, the step that position information of the liquid leakage detection line in the server is determined includes liquid leakage detection line identification information of the liquid leakage detection line is acquired, where the liquid leakage detection line identification information includes server identification information of the server where the liquid leakage detection line is located, and a serial number of the liquid leakage detection line; and the position information of the liquid leakage detection line in the server is determined according to the liquid leakage detection line identification information.

Optionally, the step that the position information of the liquid leakage detection line in the server is determined according to the liquid leakage detection line identification information includes a ranking mode of the liquid leakage detection line in the server is determined according to the server identification information; and the position information of the liquid leakage detection line in the server is determined according to the ranking mode and the serial number.

As an optional embodiment, the above position information may be number information (i.e. the serial number) of the liquid leakage detection line. Optionally, a plurality of liquid leakage detection lines are generally arranged in the cooling device, and a plurality of cooling devices may be arranged in one server. In this case, the number information of the liquid leakage detection line may include the identification information of the server where the liquid leakage detection line is located, identification information of the cooling device where the liquid leakage detection line is located, and the serial number of the liquid leakage detection line in the cooling device. Thus, the operation and maintenance personnel can rapidly determine an approximate position of the liquid leakage detection line according to the identification information of the server and the identification information of the cooling device, and further determine an accurate position of the liquid leakage detection line according to the serial number.

In some other examples of the disclosure, it is determined that the server where the liquid leakage detection line is located has a leakage failure in a case that the first measurement result indicates that the voltage value output by the second target port is not less than a second preset voltage threshold and the second measurement result indicates that the target flag bit is the second flag, where the second flag is configured to indicate that the voltage value output by the first target port is not set to the preset voltage value.

As an optional embodiment, after the step that it is determined that the server where the liquid leakage detection line is located has a leakage failure, the method for detecting a liquid leakage detection line further includes failure position information of the leakage failure in the server is determined; and second failure reminding information is generated according to the position information, and transmitted to a target object, where the failure reminding information is configured to remind the target object of the leakage failure of the server, and the failure position information of the leakage failure.

Optionally, the step that failure position information of the leakage failure in the server is determined includes liquid leakage detection line identification information of the liquid leakage detection line is acquired, where the liquid leakage detection line identification information includes server identification information of the server where the liquid leakage detection line is located, and a serial number of the liquid leakage detection line; a detection region corresponding to the liquid leakage detection line in the server is determined according to the liquid leakage detection line identification information; and the failure position information is determined according to the detection region, where the failure position information includes information of the detection region.

It should be noted that the function of the above target flag bit is to indicate whether the current liquid leakage detection line is deemed to be set to a leakage state, so as to accurately determine whether the liquid leakage detection line has the failure. Since pulling down of a leakage detection signal that is generated through leakage simulation is a type of expectable pulling down of the leakage detection signal, no alarm of leakage should be given. However, an alarm of leakage is required to be triggered when a leakage detection signal that is not generated through simulation is pulled down. However, since both pulling down of the liquid leakage detection line in-place detection GPIO and actual leakage will trigger pulling down of the leakage detection signal, it is required to set the target flag bit to distinguish between the two cases. Thus, in some examples of the disclosure, a global variable flag bit liquid leakage detection line test (i.e. the target flag bit) may be set. When the flag bit is set to 1, it is indicated that a process of actively detecting and pulling down the liquid leakage detection line in-place detection GPIO and actively simulating leakage is in progress at present. When the flag bit is set to 0, it is indicated that no active simulation of leakage is performed in this case. In the first thread, the liquid leakage detection line in-place detection GPIO is pulled down for a period of time (generally 6 s). Moreover, the liquid leakage detection line test is set to 1 while the liquid leakage detection line in-place detection GPIO is pulled down. When the liquid leakage detection line test is detected to be 1 in the second thread, if the leakage detection GPIO is detected to be low, it is indicated that the liquid leakage detection line works normally, and if the leakage detection GPIO is detected to be high, it is indicated that the liquid leakage detection line is abnormal and impossible to identify the leakage event correctly. In this case, it is required to give an alarm of an abnormality of the liquid leakage detection line, so that the operation and maintenance personnel are reminded to replace the liquid leakage detection line.

During the normal operation of the second thread of leakage detection, if the liquid leakage detection line test is detected to be 0, it is indicated that whether leakage occurs is in a normal monitoring state for the moment. In this case, if the leakage detection GPIO is detected to be low, it is indicated that the low GPIO is triggered by the actual leakage event. Thus, it is required to give an alarm of the leakage event in time, so that triggering of electrical leakage and connection events of the motherboard or a cabinet due to excessive leakage is prevented.

It can be seen that in the examples of the disclosure, through the cooperation of the leakage detection GPIO and the liquid leakage detection line in-place detection GPIO, on-line regular automatic routine inspection of the function of the liquid leakage detection line is realized. When the liquid leakage detection line is abnormal, the alarm can be given in time, and the liquid leakage detection line can be replaced. Moreover, an alarm of the actual leakage event can also be given. More serious safety issues caused after the leakage event is not identified due to the abnormality of the liquid leakage detection line are avoided.

Also, the voltage value output by the first target port is set to the preset voltage value according to the first preset frequency, and the first flag is assigned to the target flag bit, where the first flag is configured to indicate that the voltage value output by the first target port is set to the preset voltage value, and the voltage value output by the first target port is configured to adjust the resistance value of the liquid leakage detection line; the voltage value output by the second target port is measured according to the second preset frequency, so as to obtain the first measurement result, and the target flag bit is measured according to the second preset frequency, so as to obtain the second measurement result, where the voltage value output by the second target port is determined by the resistance value of the liquid leakage detection line; and the working state of the liquid leakage detection line is determined according to the first measurement result and the second measurement result. Accordingly, the problem that the working state of the liquid leakage detection line fails to be determined in time and tends to be determined mistakenly because the failure diagnosis of the liquid leakage detection line is performed with the manual routine inspection in the related art can be solved. The smooth operation of the server can be ensured.

An execution entity of the above steps can be, but is not limited to, the server, the terminal, etc.

A system for detecting a liquid leakage detection line is further provided in the example. The system is configured to implement the above example and the optional embodiment. Accordingly, the explanations and descriptions related to the above example and the optional embodiment are also applicable to the example of the disclosure, and the descriptions that have been made will not be repeated.

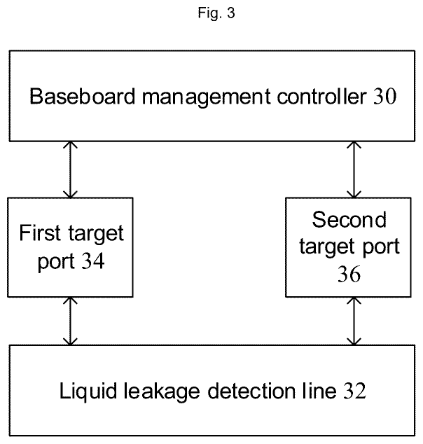

FIG. 3 is a structural block diagram of a system for detecting a liquid leakage detection line 32 according to an example of the disclosure. As shown in FIG. 3, the system includes a baseboard management controller 30, a liquid leakage detection line 32, a first target port 34, and a second target port 36; where the first target port 34 is configured to adjust a resistance value of the liquid leakage detection line 32; the second target port 36 is configured to output a voltage value determined by the resistance value of the liquid leakage detection line 32; and the baseboard management controller 30 is configured to set a voltage value output by the first target port 34 to a preset voltage value according to a first preset frequency, and assign a first flag to a target flag bit, where the first flag is configured to indicate that the voltage value output by the first target port 34 is set to the preset voltage value, and the voltage value output by the first target port 34 is configured to adjust the resistance value of the liquid leakage detection line 32; measure a voltage value output by the second target port 36 according to a second preset frequency, so as to obtain a first measurement result, and measure the target flag bit according to the second preset frequency, so as to obtain a second measurement result, where the voltage value output by the second target port 36 is determined by the resistance value of the liquid leakage detection line 32; and determine a working state of the liquid leakage detection line 32 according to the first measurement result and the second measurement result.

As an optional embodiment, the step that the above baseboard management controller 30 determines a working state of the liquid leakage detection line 32 according to the first measurement result and the second measurement result includes it is determined that the working state is a normal working state in a case that the first measurement result indicates that the voltage value output by the second target port 36 is not equal to the preset voltage value, and the second measurement result indicates that the target flag bit is the first flag; and it is determined that the working state is an abnormal working state in a case that the first measurement result indicates that the voltage value output by the second target port 36 is not a second preset voltage value, and the second measurement result indicates that the target flag bit is the first flag.

As an optional embodiment, after the step that it is determined that the working state is an abnormal working state, the above baseboard management controller 30 is further configured to determine position information of the liquid leakage detection line 32 in the server; and generate failure reminding information according to the position information, and transmit the failure reminding information to a target object, where the failure reminding information is configured to remind the target object of a failure of the liquid leakage detection line 32, and the position information of the liquid leakage detection line 32.

As an optional embodiment, the above baseboard management controller 30 is further configured to determine that the server where the liquid leakage detection line 32 is located has a leakage failure in a case that the first measurement result indicates that the voltage value output by the second target port 36 is a second preset voltage value and the second measurement result indicates that the target flag bit is a second flag, where the second flag is configured to indicate that the voltage value output by the first target port 34 is not set to the preset voltage value.

As an optional embodiment, before the step that the above baseboard management controller 30 sets a voltage value output by a first target port 34 to a preset voltage value according to a first preset frequency, a first thread and a second thread are also created, where the first thread is configured to set the voltage value output by the first target port 34 to the preset voltage value according to the first preset frequency, and assign the first flag to the target flag bit; the second thread is configured to obtain the first measurement result and the second measurement result according to the second preset frequency; and the second preset frequency is greater than the first preset frequency.

Optionally, the first thread and the second thread may be created in the baseboard management controller. The first thread is configured to periodically pull down the liquid leakage detection line in-place detection GPIO, so as to simulate a leakage event. Thus, whether the liquid leakage detection line is in place and whether the leakage event can be correctly identified are periodically monitored. The second thread is configured to periodically detect the leakage detection GPIO. Thus, whether the leakage event occurs and whether an abnormal event of the liquid leakage detection line occurs are determined. In a case of the leakage event and the abnormal event of the liquid leakage detection line, an alarm is given in time.

It should be noted that the function of the above target flag bit is to indicate whether the current liquid leakage detection line is deemed to be set to a leakage state, so as to accurately determine whether the liquid leakage detection line has the failure. Since pulling down of a leakage detection signal that is generated through leakage simulation is a type of expectable pulling down of the leakage detection signal, no alarm of leakage should be given. However, an alarm of leakage is required to be triggered when a leakage detection signal that is not generated through simulation is pulled down. However, since both pulling down of the liquid leakage detection line in-place detection GPIO and actual leakage will trigger pulling down of the leakage detection signal, it is required to set the target flag bit to distinguish between the two cases.

In some examples of the disclosure, the above system for detecting a liquid leakage detection line further includes an alarm device, where the alarm device is connected to the baseboard management controller, and configured to transmit alarm information to the target object in a case that the baseboard management controller determines that the working state of the liquid leakage detection line is an abnormal state according to the first measurement result and the second measurement result, where the alarm information includes position information of the liquid leakage detection line.

A cooling device is further provided in the example. The cooling device is configured to implement the above example and the optional embodiment. Accordingly, the explanations and descriptions related to the above example and the optional embodiment are also applicable to the example of the disclosure, and the descriptions that have been made will not be repeated.

Optionally, as shown in FIG. 6, the cooling device includes a liquid cooling plate 60, a liquid leakage detection line 32, a first target port 34, and a second target port 36; where the liquid leakage detection line 32 is arranged in the liquid cooling plate 60, and configured to detect whether the liquid cooling plate has a leakage failure; the first target port 34 is configured to adjust a resistance value of the liquid leakage detection line; and the second target port is configured to output a voltage value determined by the resistance value of the liquid leakage detection line.

A server is further provided in the example. The server is configured to implement the above example and the optional embodiment. Accordingly, the explanations and descriptions related to the above example and the optional embodiment are also applicable to the example of the disclosure, and the descriptions that have been made will not be repeated.

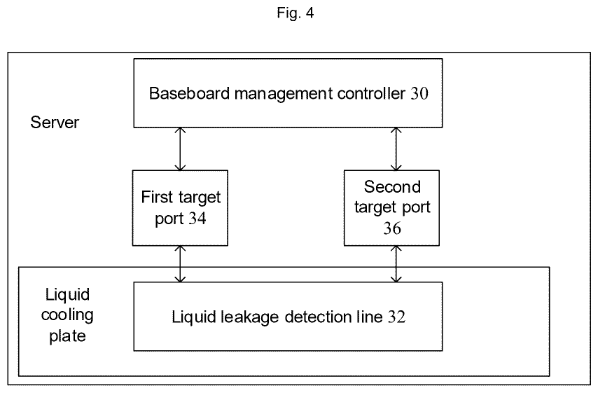

FIG. 4 is a structural block diagram of a server of a liquid leakage detection line according to an example of the disclosure. As shown in FIG. 4, the above system for detecting a liquid leakage detection line is configured in the server.

A device for detecting a liquid leakage detection line is further provided in the example. The device is configured to implement the above example and the optional embodiment. Accordingly, the explanations and descriptions related to the above example and the optional embodiment are also applicable to the example of the disclosure, and the descriptions that have been made will not be repeated. As used below, the term “module” can be a combination of software and/or hardware that implements predetermined functions. While the device described in the following example is preferably implemented through software, it is possible to conceivable that the device is implemented through hardware, or a combination of the software and the hardware.

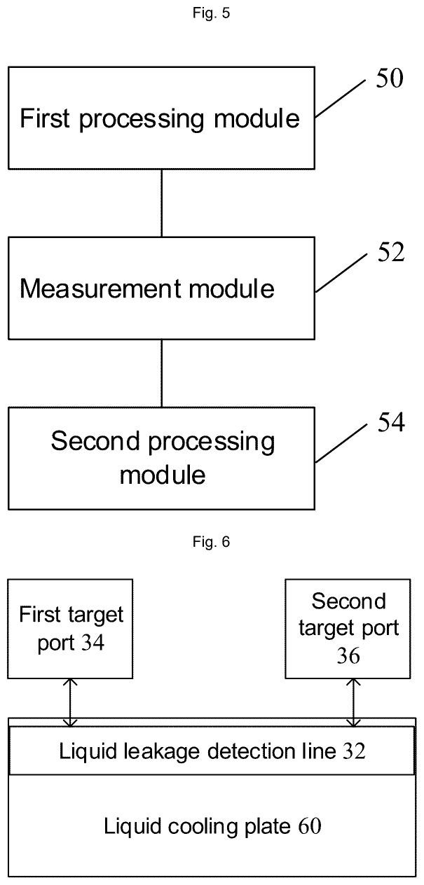

FIG. 5 is a structural block diagram of a device for detecting a liquid leakage detection line according to an example of the disclosure. As shown in FIG. 5, the device includes a first processing module 50 configured to set a voltage value output by the first target port to a preset voltage value according to a first preset frequency, and assign a first flag to a target flag bit, where the first flag is configured to indicate that the voltage value output by the first target port is set to the preset voltage value, the voltage value output by the first target port is configured to adjust a resistance value of the liquid leakage detection line, the first preset frequency is a frequency used when the voltage value output by the first target port is set to the preset voltage value, the liquid leakage detection line is arranged on a cooling device of a target motherboard, and the first target port is arranged on the target motherboard; a measurement module 52 configured to measure a voltage value output by a second target port according to a second preset frequency, so as to obtain a first measurement result, and measure the target flag bit according to the second preset frequency, so as to obtain a second measurement result, where the voltage value output by the second target port is determined by the resistance value of the liquid leakage detection line, and the second target port is arranged on the target motherboard; and a second processing module 54 configured to determine a working state of the liquid leakage detection line according to the first measurement result and the second measurement result.

In some embodiments, the step that the second processing module 54 determines a working state of the liquid leakage detection line according to the first measurement result and the second measurement result includes it is determined that the working state is a normal working state in a case that the first measurement result indicates that the voltage value output by the second target port is not greater than a first preset voltage threshold and the second measurement result indicates that the target flag bit is the first flag; and it is determined that the working state is an abnormal working state in a case that the first measurement result indicates that the voltage value output by the second target port is not less than a second preset voltage threshold and the second measurement result indicates that the target flag bit is the first flag; where the second preset voltage threshold is greater than the first preset voltage threshold.

In some examples of the disclosure, the resistance value of the liquid leakage detection line is configured to indicate whether the liquid leakage detection line detects a leakage failure; where the resistance value of the liquid leakage detection line is a first-type resistance value in a case that the voltage value output by the second target port is not greater than the first preset voltage threshold, and the first-type resistance value is configured to indicate that the liquid leakage detection line detects the leakage failure or the liquid leakage detection line is configured to detect the leakage failure; and the resistance value of the liquid leakage detection line is a second-type resistance value in a case that the voltage value output by the second target port is not less than the second preset voltage threshold, and the second-type resistance value is configured to indicate that the liquid leakage detection line detects no leakage failure.

In some examples of the disclosure, after the step that it is determined that the working state is an abnormal working state, the second processing module 54 is further configured to determine position information of the liquid leakage detection line in the server; and generate failure reminding information according to the position information, and transmit the failure reminding information to a target object, where the failure reminding information is configured to remind the target object of a failure of the liquid leakage detection line, and the position information of the liquid leakage detection line.

In some embodiments, the step that the second processing module 54 determines position information of the liquid leakage detection line in a server includes liquid leakage detection line identification information of the liquid leakage detection line is acquired, where the liquid leakage detection line identification information includes server identification information of the server where the liquid leakage detection line is located, and a serial number of the liquid leakage detection line; and the position information of the liquid leakage detection line in the server is determined according to the liquid leakage detection line identification information.

In some embodiments, the step that the second processing module 54 determines the position information of the liquid leakage detection line in the server according to the liquid leakage detection line identification information includes a ranking mode of the liquid leakage detection line in the server is determined according to the server identification information; and the position information of the liquid leakage detection line in the server is determined according to the ranking mode and the serial number.

In some examples of the disclosure, the second processing module 54 is further configured to determine that the server where the liquid leakage detection line is located has a leakage failure in a case that the first measurement result indicates that the voltage value output by the second target port is not less than a second preset voltage threshold and the second measurement result indicates that the target flag bit is the second flag, where the second flag is configured to indicate that the voltage value output by the first target port is not set to the preset voltage value.

In some embodiments, after the step that it is determined that the server where the liquid leakage detection line is located has a leakage failure, the second processing module 54 is further configured to determine failure position information of the leakage failure in the server; and generate second failure reminding information according to the position information, and transmit the second failure reminding information to a target object, where the failure reminding information is configured to remind the target object of the leakage failure of the server, and the failure position information of the leakage failure.

In some examples of the disclosure, the step that the second processing module 54 determines failure position information of the leakage failure in the server includes liquid leakage detection line identification information of the liquid leakage detection line is acquired, where the liquid leakage detection line identification information includes server identification information of the server where the liquid leakage detection line is located, and a serial number of the liquid leakage detection line; a detection region corresponding to the liquid leakage detection line in the server is determined according to the liquid leakage detection line identification information; and the failure position information is determined according to the detection region, where the failure position information includes information of the detection region.

In some embodiments, before the step that the first processing module sets a voltage value output by a first target port to a preset voltage value according to a first preset frequency, the first processing module 50 is further configured to create a first thread and a second thread; where the first thread is configured to set the voltage value output by the first target port to the preset voltage value according to the first preset frequency, and assign the first flag to the target flag bit; the second thread is configured to obtain the first measurement result and the second measurement result according to the second preset frequency; and the second preset frequency is greater than the first preset frequency.

It should be noted that each module described above can be implemented through software or hardware. In the latter case, the modules can be implemented in, but not limited to, the following manners: the above modules are positioned in the same processor; and alternatively, the above modules are positioned in different processors in any combination.

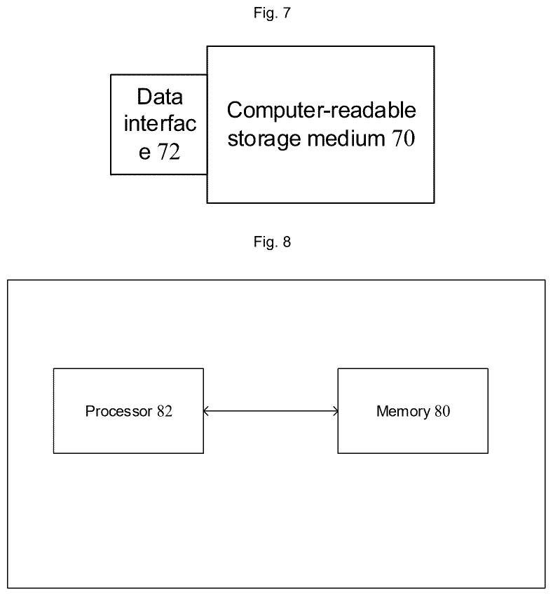

A computer non-volatile readable storage medium 70 shown in FIG. 7 is further provided in the examples of the disclosure. The computer non-volatile readable storage medium 70 stores a computer program, where the computer program is configured to execute steps of any method example described above when run. For example, the computer program may execute a method for detecting a liquid leakage detection line as follows when run: a voltage value output by a first target port is set to a preset voltage value according to a first preset frequency, and a first flag is assigned to a target flag bit, where the first flag is configured to indicate that the voltage value output by the first target port is set to the preset voltage value, the voltage value output by the first target port is configured to adjust a resistance value of the liquid leakage detection line, the first preset frequency is a frequency used when the voltage value output by the first target port is set to the preset voltage value, the liquid leakage detection line is arranged on a cooling device of a target motherboard, and the first target port is arranged on the target motherboard; a voltage value output by a second target port is measured according to a second preset frequency, so as to obtain a first measurement result, and the target flag bit is measured according to the second preset frequency, so as to obtain a second measurement result, where the voltage value output by the second target port is determined by the resistance value of the liquid leakage detection line, and the second target port is arranged on the target motherboard; and a working state of the liquid leakage detection line is determined according to the first measurement result and the second measurement result.

In some embodiments, the computer non-volatile readable storage medium 70 may include, but is not limited to, various media capable of storing a computer program, such as a universal serial bus (USB) flash disk, a read-only memory (ROM), a random access memory (RAM), a mobile hard disk, a magnetic disk, an optical disk, etc.

Also, as shown in FIG. 7, the above computer non-volatile readable storage medium 70 is further provided with a data interface 72 through which an electronic apparatus, a processor, etc. can read data from the computer non-volatile readable storage medium 70 or write data into the computer non-volatile readable storage medium.

An electronic apparatus shown in FIG. 8 is further provided in the examples of the disclosure. The electronic apparatus includes a memory 80 and a processor 82; where the memory 80 stores a computer program; and the processor 82 is configured to run the computer program, so as to execute steps of any method example described above. For example, the processor 82 may be configured to execute a method for detecting a liquid leakage detection line as follows: a voltage value output by a first target port is set to a preset voltage value according to a first preset frequency, and a first flag is assigned to a target flag bit, where the first flag is configured to indicate that the voltage value output by the first target port is set to the preset voltage value, the voltage value output by the first target port is configured to adjust a resistance value of the liquid leakage detection line, the first preset frequency is a frequency used when the voltage value output by the first target port is set to the preset voltage value, the liquid leakage detection line is arranged on a cooling device of a target motherboard, and the first target port is arranged on the target motherboard; a voltage value output by a second target port is measured according to a second preset frequency, so as to obtain a first measurement result, and the target flag bit is measured according to the second preset frequency, so as to obtain a second measurement result, where the voltage value output by the second target port is determined by the resistance value of the liquid leakage detection line, and the second target port is arranged on the target motherboard; and a working state of the liquid leakage detection line is determined according to the first measurement result and the second measurement result.

In some embodiments, the above electronic apparatus may further include a transmission apparatus and an input/output apparatus, where the transmission apparatus is connected to the above processor 82, and the input/output apparatus is connected to the above processor 82.

In the above examples of the disclosure, the description of each example has its own emphasis. Reference can be made to the relevant description in other examples for the part not described in detail in one example.

In several examples provided in the disclosure, it should be understood that the technical contents disclosed can be implemented in other ways. The device example described above is merely illustrative. For example, the units are divided by logical function. Other division methods can be employed during actual implementation. For example, a plurality of units or components can be combined or integrated into another system. Alternatively, it is possible to omit or not execute some features. Further, mutual coupling, direct coupling, or communication connection shown or discussed can be indirect coupling or communication connection through some interfaces, units, or modules in an electrical manner, etc.

The unit described as a separate component can be physically separated or not. The component shown as a unit may be a physical unit or not. In other words, the components can be positioned in one place or distributed over a plurality of units. Some or all units can be selected according to actual demands to implement the solution in the example.

Also, all function units in each example of the disclosure can be integrated into one processing unit. Each unit can also be physically present alone. Two or more units can also be integrated into one unit. The above integrated units can be implemented in a form of hardware or software function units.

If being implemented in the form of software function units and sold or used as independent products, the integrated units can be stored in one computer non-volatile readable storage medium. Based on such understanding, the technical solutions of the disclosure in essence, the part that contributes to the related art, or all or some of the technical solutions can be embodied in a form of a software product. The computer software product is stored in one non-volatile readable storage medium and includes several instructions configured to enable a computer apparatus (which can be a personal computer, a server, a network apparatus, etc.) to execute all or some of the steps of the method in each example of the disclosure. The foregoing non-volatile readable storage medium includes: various media capable of storing a program code, such as a USB flash disk, a read-only memory (ROM), a random access memory (RAM), a mobile hard disk, a magnetic disk, and an optical disk.

What are described above are merely optional embodiments of the disclosure. It should be pointed out that those of ordinary skill in the art can make several improvements and modifications without departing from the principles of the disclosure, and these improvements and modifications should also be deemed as falling within the scope of protection of the disclosure.

1. A method for detecting a liquid leakage detection line, comprising:
setting a voltage value output by a first target port to a preset voltage value according to a first preset frequency, and assigning a first flag to a target flag bit, wherein the first flag is configured to indicate that the voltage value output by the first target port is set to the preset voltage value, the voltage value output by the first target port is configured to adjust a resistance value of the liquid leakage detection line, the first preset frequency is a frequency used when the voltage value output by the first target port is set to the preset voltage value, the liquid leakage detection line is arranged on a cooling device of a target motherboard, and the first target port is arranged on the target motherboard;
measuring a voltage value output by a second target port according to a second preset frequency, so as to obtain a first measurement result, and measuring the target flag bit according to the second preset frequency, so as to obtain a second measurement result, wherein the voltage value output by the second target port is determined by the resistance value of the liquid leakage detection line, and the second target port is arranged on the target motherboard; and
determining a working state of the liquid leakage detection line according to the first measurement result and the second measurement result.

2. The method for detecting the liquid leakage detection line according to claim 1, wherein determining the working state of the liquid leakage detection line according to the first measurement result and the second measurement result comprises:
determining that the working state is a normal working state in a case that the first measurement result indicates that the voltage value output by the second target port is not greater than a first preset voltage threshold and the second measurement result indicates that the target flag bit is the first flag; and
determining that the working state is an abnormal working state in a case that the first measurement result indicates that the voltage value output by the second target port is not less than a second preset voltage threshold and the second measurement result indicates that the target flag bit is the first flag; wherein the second preset voltage threshold is greater than the first preset voltage threshold.

3. The method for detecting the liquid leakage detection line according to claim 2, wherein the abnormal working state comprises at least one of aging of the liquid leakage detection line and breakage of the liquid leakage detection line.

4. The method according to claim 2, wherein the resistance value of the liquid leakage detection line is configured to indicate whether the liquid leakage detection line detects a leakage failure; the resistance value of the liquid leakage detection line is a first-type resistance value in a case that the voltage value output by the second target port is not greater than the first preset voltage threshold, and the first-type resistance value is configured to indicate that the liquid leakage detection line detects the leakage failure; and
the resistance value of the liquid leakage detection line is a second-type resistance value in a case that the voltage value output by the second target port is not less than the second preset voltage threshold, and the second-type resistance value is configured to indicate that the liquid leakage detection line detects no leakage failure.

5. The method for detecting the liquid leakage detection line according to claim 2, wherein after the determining that the working state is the abnormal working state, the method for detecting a liquid leakage detection line further comprises:
determining position information of the liquid leakage detection line in a server;
generating first failure reminding information according to the position information, and transmitting the first failure reminding information to a target object, wherein the first failure reminding information is configured to remind the target object of a failure of the liquid leakage detection line, and the position information of the liquid leakage detection line.

6. The method for detecting the liquid leakage detection line according to claim 5, wherein determining position information of the liquid leakage detection line in the server comprises:
acquiring liquid leakage detection line identification information of the liquid leakage detection line, wherein the liquid leakage detection line identification information comprises server identification information of the server where the liquid leakage detection line is located, and a serial number of the liquid leakage detection line; and
determining the position information of the liquid leakage detection line in the server according to the liquid leakage detection line identification information.

7. The method for detecting the liquid leakage detection line according to claim 6, wherein determining the position information of the liquid leakage detection line in the server according to the liquid leakage detection line identification information comprises:
determining a ranking mode of the liquid leakage detection line in the server according to the server identification information; and
determining the position information of the liquid leakage detection line in the server according to the ranking mode and the serial number.

8. The method for detecting the liquid leakage detection line according to claim 1, the method for detecting the liquid leakage detection line further comprising:
determining that the server where the liquid leakage detection line is located has a leakage failure in a case that the first measurement result indicates that the voltage value output by the second target port is not less than a second preset voltage threshold and the second measurement result indicates that the target flag bit is a second flag, wherein the second flag is configured to indicate that the voltage value output by the first target port is not set to the preset voltage value.

9. The method for detecting the liquid leakage detection line according to claim 8, wherein after the determining that the server where the liquid leakage detection line is located has the leakage failure, the method for detecting the liquid leakage detection line further comprises:
determining failure position information of the leakage failure in the server; and
generating second failure reminding information according to the position information, and transmitting the second failure reminding information to a target object, wherein the failure reminding information is configured to remind the target object of the leakage failure of the server, and the failure position information of the leakage failure.

10. The method for detecting the liquid leakage detection line according to claim 9, wherein determining failure position information of the leakage failure in the server comprises:
acquiring liquid leakage detection line identification information of the liquid leakage detection line, wherein the liquid leakage detection line identification information comprises server identification information of the server where the liquid leakage detection line is located, and a serial number of the liquid leakage detection line;
determining a detection region corresponding to the liquid leakage detection line in the server according to the liquid leakage detection line identification information; and
determining the failure position information according to the detection region, wherein the failure position information comprises information of the detection region.

11. The method according to claim 1, wherein before the setting the voltage value output by the first target port to a preset voltage value according to the first preset frequency, the method for detecting the liquid leakage detection line further comprises:
creating a first thread and a second thread, wherein the first thread is configured to set the voltage value output by the first target port to the preset voltage value according to the first preset frequency, and assign the first flag to the target flag bit; the second thread is configured to obtain the first measurement result and the second measurement result according to the second preset frequency; and the second preset frequency is greater than the first preset frequency.

12. The method according to claim 11, wherein the first thread is further configured to cancel setting of the voltage value output by the first target port to the preset voltage value, and assign a second flag to the target flag bit, with an interval of a preset time period after the voltage value output by the first target port is set to the preset voltage value, and the first flag is assigned to the target flag bit.

13. The method according to claim 12, wherein duration of the preset time period is longer than that of a time cycle corresponding to the second preset frequency.

14. A cooling device, comprising a liquid cooling plate, a liquid leakage detection line, a first target port, and a second target port; wherein
the liquid leakage detection line is arranged in the liquid cooling plate, and configured to detect whether the liquid cooling plate has a leakage failure;
the first target port is configured to adjust a resistance value of the liquid leakage detection line; and
the second target port is configured to output a voltage value determined by the resistance value of the liquid leakage detection line.

15. A system for detecting a liquid leakage detection line, comprising a baseboard management controller, a liquid leakage detection line, a first target port, and a second target port; wherein
the first target port is configured to adjust a resistance value of the liquid leakage detection line;
the second target port is configured to output a voltage value determined by the resistance value of the liquid leakage detection line; and
the baseboard management controller is configured to set a voltage value output by the first target port to a preset voltage value according to a first preset frequency, and assign a first flag to a target flag bit, wherein the first flag is configured to indicate that the voltage value output by the first target port is set to the preset voltage value, the voltage value output by the first target port is configured to adjust the resistance value of the liquid leakage detection line, the first preset frequency is a frequency used when the voltage value output by the first target port is set to the preset voltage value, the liquid leakage detection line is arranged on a cooling device of a target motherboard, and the first target port is arranged on the target motherboard; measure a voltage value output by the second target port according to a second preset frequency, so as to obtain a first measurement result, and measure the target flag bit according to the second preset frequency, so as to obtain a second measurement result, wherein the voltage value output by the second target port is determined by the resistance value of the liquid leakage detection line, and the second target port is arranged on the target motherboard; and
determine a working state of the liquid leakage detection line according to the first measurement result and the second measurement result.

16. The system for detecting a liquid leakage detection line according to claim 15, further comprising an alarm device, wherein
the alarm device is connected to the baseboard management controller, and configured to transmit alarm information to a target object in a case that the baseboard management controller determines that the working state of the liquid leakage detection line is an abnormal state according to the first measurement result and the second measurement result, and the alarm information comprises position information of the liquid leakage detection line.

17. (canceled)

18. (canceled)

19. (canceled)

20. (canceled)

21. The system for detecting a liquid leakage detection line according to claim 15, wherein the baseboard management controller is configured to determine a working state of the liquid leakage detection line according to the first measurement result and the second measurement result comprises:
the baseboard management controller is configured to determine that the working state is a normal working state in a case that the first measurement result indicates that the voltage value output by the second target port is not greater than a first preset voltage threshold and the second measurement result indicates that the target flag bit is the first flag; and
the baseboard management controller is configured to determine that the working state is an abnormal working state in a case that the first measurement result indicates that the voltage value output by the second target port is not less than a second preset voltage threshold and the second measurement result indicates that the target flag bit is the first flag; wherein the second preset voltage threshold is greater than the first preset voltage threshold.

22. The system for detecting a liquid leakage detection line according to claim 21,
the baseboard management controller is further configured to determine position information of the liquid leakage detection line in a server, generate first failure reminding information according to the position information, and transmit the first failure reminding information to a target object, after the baseboard management controller is configured to determine that the working state is the abnormal working state, wherein the first failure reminding information is configured to remind the target object of a failure of the liquid leakage detection line, and the position information of the liquid leakage detection line.

23. The system for detecting a liquid leakage detection line according to claim 15, the baseboard management controller is further configured to determine that the server where the liquid leakage detection line is located has a leakage failure in a case that the first measurement result indicates that the voltage value output by the second target port is not less than a second preset voltage threshold and the second measurement result indicates that the target flag bit is a second flag, wherein the second flag is configured to indicate that the voltage value output by the first target port is not set to the preset voltage value.

24. The system for detecting a liquid leakage detection line according to claim 15, the baseboard management controller is further configured to create a first thread and a second thread, before the baseboard management controller is configured to set the voltage value output by the first target port to a preset voltage value according to the first preset frequency, wherein the first thread is configured to set the voltage value output by the first target port to the preset voltage value according to the first preset frequency, and assign the first flag to the target flag bit; the second thread is configured to obtain the first measurement result and the second measurement result according to the second preset frequency; and the second preset frequency is greater than the first preset frequency.
